(19) United States
(12) Patent Application Publication
(10) Pub. No.: US 2009/0122343 A1
(43) Pub. Date: May 14, 2009

(54) Transmission terminal, information output device, and content transmission system

(75) Inventor: Masanobu Nishitani, Suwa-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/291,772

(22) Filed: Nov. 13, 2008

(30) Foreign Application Priority Data
Nov. 14, 2007 (JP) 2007-295652
Jan. 16, 2008 (JP) 2008-6875
Oct. 16, 2008 (JP) 2008-267080

(51) Int. Cl. G06F 3/12; G06F 15/173; G06F 15/00; G06F 15/16

(52) U.S. Cl. 358/1.15; 709/223; 709/227

(57) ABSTRACT

Prior to transmission of content data, a personal computer 104 and a printing terminal 108 establish a session between the personal computer 104 and the printing terminal 108 via an SIP server 106 by an SIP protocol. In the course of establishment of the session, the personal computer 104 sends a set of printing conditions, which is adopted by the printing terminal 108 for printing a content based on the received content data, to the printing terminal 108 via the SIP server 106. In this manner, the set of printing conditions as an output condition is transmittable from the personal computer 104 as a transmission terminal to the printing terminal 108 as an information output device.

### BACKGROUND OF THE INVENTION

1. Field of the Invention

The present invention relates to a technique of transmitting content data via a network. In the specification hereof, the terminology of ‘content’ means any of information like images and sounds, and ‘content data’ means data representing such contents. Among these contents, printable ones such as images may be specifically referred to as ‘print contents’.

2. Description of the Related Art

Companies generally deliver advertisements to their customers by mail or by facsimile. The mail and the facsimile are also used for delivery of materials for distance learning from correspondence organizations to their students.

The mail delivery system provides the respective customers or students with high-quality prints of advertisements or materials as print contents. The mail delivery system, however, requires the large manpower for the mail delivery, thus undesirably increasing the cost and taking rather long time for the delivery.

The facsimile delivery system, on the other hand, does not require the large manpower or the long time, compared with the mail delivery system. The facsimile delivery system, however, still needs the communication cost and does not provide the customers or students with the high-quality print contents.

The latest advancement of the Internet and other networks enables very low-cost transmission of information. The development of high-performance printers and complex machines enables relatively low-cost and high-quality printing in homes.

It is highly demanded to develop a system of enabling print content data to be delivered at low cost and with high quality via the Internet or another network from a transmission terminal, such as a personal computer or a server, to a printing terminal, such as a printer or a complex machine.

Known techniques for transmission of information via a network are disclosed in, for example, Japanese Patent Laid-Open No. 2005-109701 and No. 2003-178028 and Patent Application Publication No. 2005-516320.

In the system, it is required to transmit printing conditions, such as the paper size and the printing quality, from a transmission terminal to a printing terminal in the course of delivery of data of a desired print content from the transmission terminal to the printing terminal. Otherwise the printing terminal prints the desired print content according to only a default set of printing conditions. It is accordingly an important issue to adequately transmit the printing conditions from the transmission terminal to the printing terminal.

This issue is not restricted to transmission of print content data from the transmission terminal to the printing terminal. It is also important to adequately transmit display conditions, such as a display resolution, from a transmission terminal to a display in the course of delivery of content data, such as images, from the transmission terminal to the display. Similarly it is important to adequately transmit audio output conditions, such as a mute condition, from a transmission terminal to an audio device in the course of delivery of content data, such as sound, from the transmission terminal to the audio device.

In the description hereafter, the printing terminal, the display, and the audio device may be collectively referred to as an information output device. The printing conditions, the display conditions, and the audio output conditions may be collectively referred to as an output condition for output of information from the information output device.

### SUMMARY OF THE INVENTION

In order to solve the problem of the prior art described above, there would be a demand for transmitting the output condition from a transmission terminal to an information output device.

The present invention accomplishes at least part of the demand mentioned above and the other relevant demands by the following configurations applied to the transmission terminal, the information output device, and the content transmission system.

According to one aspect, the present invention is directed to a transmission terminal constructed to send content data to an information output device via a network. The transmission terminal has a controller configured to establish a session with the information output device via a mediation server connecting with the network by a signaling protocol, prior to sending the content data. The controller sends an output condition, which is adopted by the information output device for outputting information based on the content data, via the mediation server to the information output device in the course of establishment of the session.

Prior to transmission of the content data to the information output device, the transmission terminal according to this aspect of the invention transmits the output condition to the information output device via the mediation server in the course of establishment of the session with the information output device. The information output device then outputs the information according to the output condition received from the transmission terminal, based on the content data received from the transmission terminal. This arrangement enables the information output device to give an information output result meeting the sender (transmission terminal) user's requirement, based on the received content data.

In one preferable embodiment of the invention, the transmission terminal further has an image scanner configured to scan an image according to a scanning condition and obtain image data of the scanned image as the content data. The controller sends the scanning condition as the output condition to the information output device via the mediation server in the course of establishment of the session.

The transmission terminal of this embodiment scans an image according to the scanning condition and obtains the image data of the scanned image as the content data. In the course of establishment of the session, the transmission terminal sends the scanning condition as the output condition to the information output device via the mediation server. The information output device then outputs the information according to the received output condition, that is, the scanning condition adopted for scanning the image, based on the content data received from the transmission terminal. This arrangement enables the information output device to give an information output result meeting the sender (transmission terminal) user's requirement.

In one preferable application of the transmission terminal according to the above aspect of the invention, the signaling protocol is SIP protocol, and the controller includes the output condition in an INVITE request, which is sent to the information output device via the mediation server by the SIP protocol.

In the application of using the SIP protocol as the signaling protocol, the output condition is included in the INVITE request. The output condition is thus securely transmitted from the transmission terminal to the information output device in the course of establishment of the session between the transmission terminal and the information output device.

In another preferable application of the transmission terminal according to the above aspect of the invention, the controller sends multiple different conditions as the output condition.

In this application, the transmission terminal sends the multiple different conditions as the output condition to the information output device. This arrangement enables the information output device to select a desired condition among the received multiple different conditions.

In the transmission terminal of this application, when the controller plans to send multiple different data as the content data to the information output device after establishment of the session, the multiple different conditions are respectively provided corresponding to the multiple different data.

When the multiple data are to be sent as the content data, the transmission terminal sets a condition corresponding to each of the multiple data as the output condition and transmits the multiple corresponding conditions to the information output device.

In still another preferable application of the transmission terminal according to the above aspect of the invention, the controller sends data corresponding to the output condition as the content data by a data transfer protocol after establishment of the session.

The transmission terminal of this application sends data corresponding to the output condition transmitted to the information output device as the content data to the information output device. The information output device then outputs the information based on the received content data. This arrangement enables the information output device to give an information output result meeting the sender (transmission terminal) user's requirement.

According to another aspect, the invention is also directed to an information output device constructed to receive content data from a transmission terminal via a network and output information based on the received content data. The information output device has a controller configured to establish a session with the transmission terminal via a mediation server connecting with the network by a signaling protocol, prior to receiving the content data. The controller receives an output condition, which is adopted for outputting the information based on the content data, in the course of establishment of the session, and sends back a response to the output condition to the transmission terminal via the mediation server.

The information output device according to this aspect of the invention sends back the response to the transmitted output condition to the transmission terminal via the mediation server, in the course of establishment of the session with the transmission terminal.

In one preferable application of the information output device according to the above aspect of the invention, the controller determines whether output of the information according to the received output condition is enabled or disabled and sends back a result of the determination as the response to the output condition to the transmission terminal via the mediation server.

The information output device of this application determines whether the output of the information according to the received output condition is enabled or disabled and sends back the result of the determination to the transmission terminal. The transmission terminal is thus notified of the output condition desired by the information output device and sends content data corresponding to the desired output condition to the information output device.

In another preferable application of the information output device according to the above aspect of the invention, when receiving multiple different conditions as the output condition in the course of establishment of the session, the controller selects a desired condition among the multiple different conditions and sends back a result of the selection as the response to the output condition to the transmission terminal via the mediation server.

The information output device of this application selects a desired condition among the multiple different conditions and sends back the result of the selection to the transmission terminal. The transmission terminal is thus notified of the output condition desired by the information output device and sends content data corresponding to the desired output condition to the information output device.

According to still another aspect, the invention is further directed to a content transmission system constructed to transmit content data via a network. The content transmission system includes: a transmission terminal connected to the network and configured to send the content data via the network; an information output device connected to the network and configured to receive the content data from the transmission terminal and output information based on the received content data; and a mediation server connected to the network. Prior to transmission of the content data, the transmission terminal and the information output device establish a session between the transmission terminal and the information output device via the mediation server by a signaling protocol. In the course of establishment of the session, the transmission terminal sends an output condition, which is adopted by the information output device for outputting the information based on the content data, to the information output device via the mediation server.

This arrangement of the content transmission system exerts the same effects as those of the transmission terminal explained above.

The present invention is not restricted to the transmission terminal, the information output device, or the content transmission system described above. Another application of the invention is an output condition transmission method of transmitting an output condition, which is adopted for outputting information based on content data, in a content transmission system constructed to transmit the content data via a network. The content transmission system includes: a transmission terminal connected to the network and configured to send the content data via the network; an information output device connected to the network and configured to receive the content data from the transmission terminal and output information based on the received content data; and a mediation server connected to the network. Prior to transmission of the content data, the output condition transmission method causes the transmission terminal and the information output device to establish a session between the transmission terminal and the information output device via the mediation server by a signaling protocol. In the course of establishment of the session, the output condition transmission method causes the transmission terminal to send the output condition to the information output device via the mediation server.

This arrangement of the output condition transmission method exerts the same effects as those of the transmission terminal explained above.

The present invention may be actualized by diversity of other applications, for example, computer programs configured to actualize any of the transmission terminal, the information output device, the content transmission system, and the corresponding methods and recording media in which such computer programs are recorded.

### BRIEF DESCRIPTION OF THE DRAWINGS

FIG. 1 is a block diagram schematically illustrating the configuration of a content transmission system in a first embodiment of the invention;

FIG. 2 is a block diagram showing the primary structure of a personal computer included in the content transmission system of FIG. 1;

FIG. 3 is a block diagram showing the primary structure of a SIP server included in the content transmission system of FIG. 1;

FIG. 4 shows general classification of the SIP server;

FIG. 5 is a block diagram showing the primary structure of a printing terminal included in the content transmission system of FIG. 1;

FIG. 6 shows a sequence of session establishment between the personal computer and the printing terminal in the content transmission system of FIG. 1;

FIG. 7 shows printing conditions correlated to the existing SDP protocol;

FIG. 8 is a flowchart showing a printing condition transmission routine executed in the content transmission system of FIG. 1;

FIG. 9 is a flowchart showing a printing condition transmission routine executed in a content transmission system of a second embodiment;

FIG. 10 is a flowchart showing an offerer processing flow included in a printing condition transmission routine executed in a content transmission system of a third embodiment;

FIG. 11 is a flowchart showing an answerer processing flow included in the printing condition transmission routine executed in the content transmission system of the third embodiment;

FIG. 12 is a block diagram schematically illustrating the configuration of a content transmission system in a fourth embodiment of the invention; and

FIG. 13 is a block diagram showing the primary structure of a transmission terminal included in the content transmission system of FIG. 12.

### DESCRIPTION OF THE PREFERRED EMBODIMENTS

Some modes of carrying out the invention are described below as preferred embodiments in the following sequence with reference to the accompanied drawings:

A. First Embodiment
A-1. System Configuration
A-2. System Operation
A-3. Effects of Embodiment

B. Second Embodiment
B-1. System Configuration
B-2. System Operation
B-3. Effects of Embodiment

C. Third Embodiment
C-1. System Configuration
C-2. System Operation
C-3. Effects of Embodiment

D. Fourth Embodiment
D-1. System Configuration
D-2. System Operation
D-3. Effects of Embodiment

E. Other Aspects

### A. First Embodiment

### A-1. System Configuration

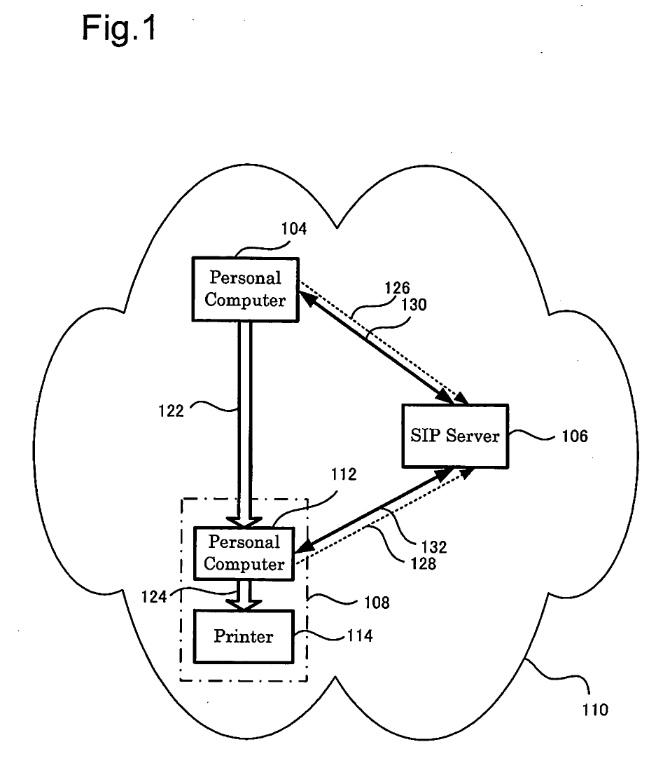

FIG. 1 is a block diagram schematically illustrating the configuration of a content transmission system in a first embodiment of the invention.

As shown in FIG. 1, the content transmission system of the first embodiment includes a personal computer 104, a SIP (Session Initiation Protocol) server 106, and a printing terminal 108 as an information output device. The personal computer 104 is managed by a sender user desiring delivery of print contents (for example, advertisements or materials for distance learning). The printing terminal 108 is managed by a receiver user receiving the delivered print contents. The SIP server 106 is managed by, for example, a network service provider.

The personal computer 104, the SIP server 106, and the printing terminal 108 are interconnected via a broadband network 110, such as the Internet.

In the content transmission system of this embodiment, each print content, such as an advertisement or a material for distance learning, is delivered as content data in a ‘push’ type by the personal computer 104 to the printing terminal 108 as discussed later in detail. The content data used for such printing may be any of diverse data representing images and documents, for example, JPEG data, GIF data, PNG data, TIFF data, plain text data, HTML data, PDF data, and PostScript (registered trademark) data. When the model of a printer adopted for the printing terminal is known, the content data may be delivered in the form of print data. In the ‘push type’ delivery, a server unilaterally sends information to the terminal without any information request from the terminal. HTTP (Hypertext Transfer Protocol) as one type of data transfer protocol is used for actual delivery of the content data or for transmission of the content data between the devices.

In the content transmission system of this embodiment, prior to delivery of the content data, a session is established between devices, that is, between the personal computer 104 and the printing terminal 108, via the SIP server 106 by a SIP (Session Initiation Protocol) as one type of signaling protocol. In the course of establishment of the session in this embodiment, the personal computer 104 transmits printing conditions for printing the content data to the printing terminal 108 via the SIP server 106. Here the ‘session’ is established to allow transmission of media streams between terminals and other nodes. The printing conditions include, for example, a paper size (size A4, size B5, size L), a printing color (chromatic, monochromatic), and a printing quality (quality level 1, quality level 2).

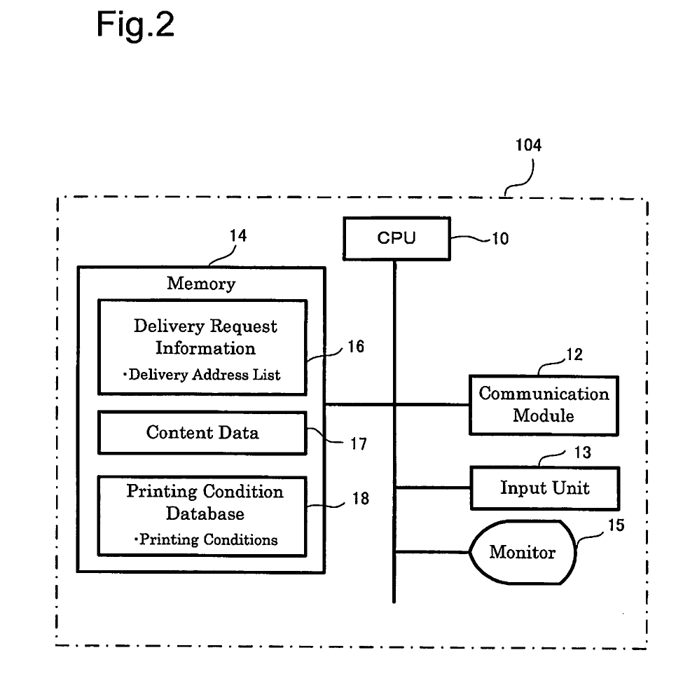

FIG. 2 is a block diagram showing the primary structure of the personal computer 104 included in the content transmission system of FIG. 1. As shown in FIG. 2, the personal computer 104 mainly includes a CPU 10 configured to perform diversity of processing operations and controls according to programs, a communication module 12 configured to transmit various data and information to and from other devices via a network, an input unit 13 constructed to have a keyboard and a pointing device and configured to enter the user's instructions and commands, a memory 14 configured to store programs as well as data and information therein, and a monitor 15 configured to display the obtained data and information. The memory 14 is capable of storing delivery request information 16, content data 17, and a printing condition database 18 as part of the storable data and information as explained later.

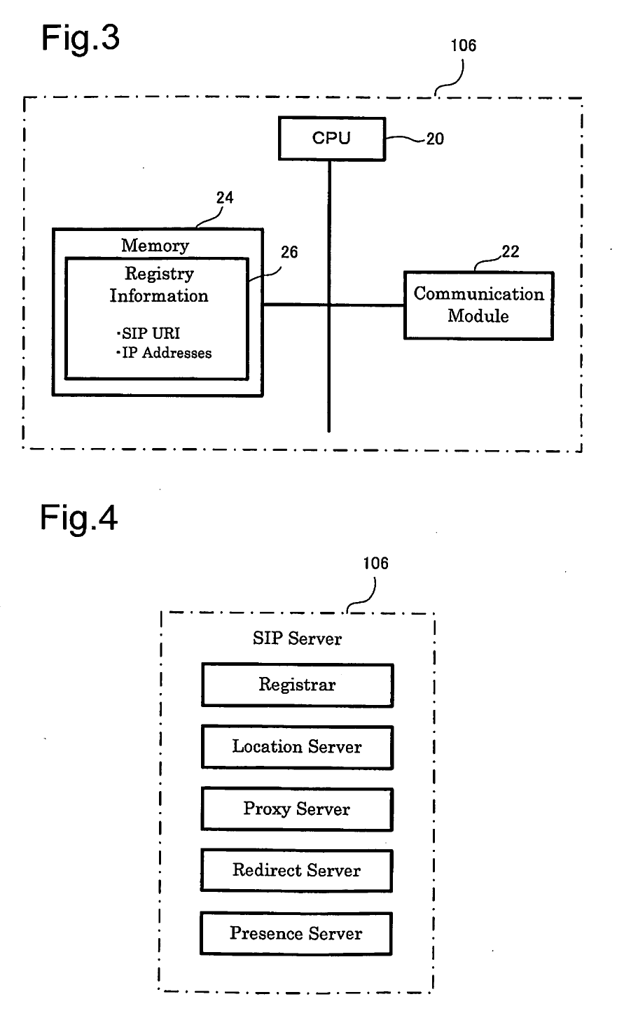

FIG. 3 is a block diagram showing the primary structure of the SIP server 106 included in the content transmission system of FIG. 1. As shown in FIG. 3, the SIP server 106 is constructed by a server computer and mainly includes a CPU 20 configured to perform diversity of processing operations and controls according to programs, a communication module 22 configured to transmit various data and information to and from other devices via a network, and a memory 24 configured to store programs as well as data and information therein. The memory 24 is capable of storing registry information 26 as part of the storable information as explained later. The SIP server 106 also has an input unit, such as a keyboard and a pointing device, and a display unit, such as a monitor, in addition to the above primary components, although these additional components are omitted from the illustration.

FIG. 4 shows general classification of SIP servers. The SIP servers are generally classified into multiple types of FIG. 4 according to its functions.

A registrar receives a registration request from each SIP client (SIP user agent) and registers an IP address (SIP URI (Uniform Resource Identifier)) and location information (for example, IP (Internet Protocol) address) of the SIP client into a location server.

The location server is a database for storing SIP addresses and location information of SIP clients and servers.

A proxy server relays requests and responses between SIP clients and mediates sessions between the SIP clients.

A redirect server notifies a SIP client of location information of a desired transmission destination in response to an inquiry from the SIP client.

A presence server obtains and manages presence information regarding each SIP-client and provides another SIP client with the obtained and managed presence information.

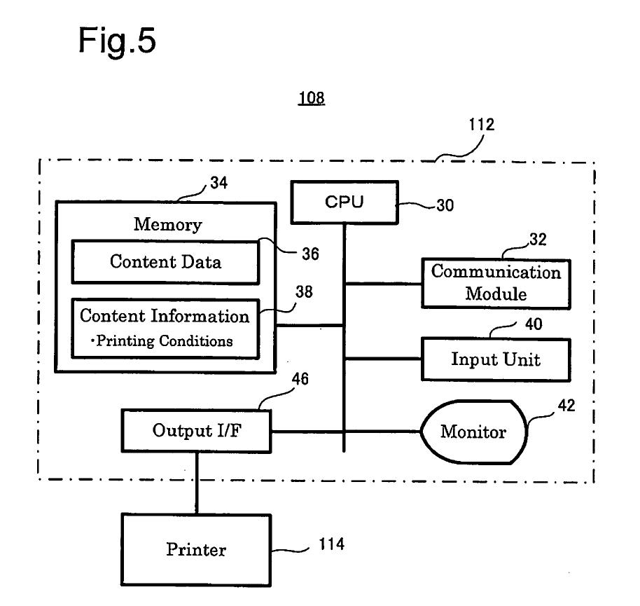

FIG. 5 is a block diagram showing the primary structure of the printing terminal 108 included in the content transmission system of FIG. 1. As shown in FIG. 1, the printing terminal 108 has a personal computer 112 and a printer 114 connected with the personal computer 112 by a USB cable or another equivalent means. As illustrated in FIG. 5, the personal computer 112 mainly includes a CPU 30 configured to perform diversity of processing operations and controls according to programs, a communication module 32 configured to transmit various data and information to and from other devices via a network, a memory 34 configured to store programs as well as data and information therein, an input unit 40 constructed to have a keyboard and a pointing device and configured to enter the user's instructions and commands, a monitor 42 configured to display the obtained data and information, and an output interface (I/F) 46 configured to output data to the externally connected printer 114 or another externally connected device. The memory 34 is capable of storing content data 36 and content information 38 as part of the storable data and information as explained later.

In the content transmission system of this embodiment, the printing terminal 108 is constructed to have the personal computer 112 and the printer 114 directly connected with the personal computer 112 by the USB cable or another equivalent means. The printing terminal 108 is, however, not restricted to this construction but may have any of other various arrangements.

In one modified arrangement, the printer 114 may be replaced with a complex machine. In another modified arrangement, the printing terminal 108 may be constructed by the personal computer 112 and a network-ready complex machine or printer connected to the personal computer 112 via a LAN (local area network) by a LAN cable or another equivalent means. In still another modified arrangement, the printing terminal 108 may be constructed by the personal computer 112, a network adapter connected to the personal computer 112 via a LAN by a LAN cable or another equivalent means, and a complex machine or a printer connected to the network adapter by a USB cable or another equivalent means.

In another modified arrangement, the printing terminal 108 may be constructed by an IP (Internet Protocol) printing-compatible complex machine or printer alone. The IP printing-compatible complex machine or printer is able to directly handle global addresses, such as SIP URIs. Direct connection of the IP printing-compatible complex machine or printer to a broadband network, such as the Internet, via a broadband router accordingly allows data transmission to and from an external device on the network. Here the IP printing represents a printing mode satisfying the following conditions:

utilizing a network;

using a call control protocol, such as SIP, as a communication protocol;

allowing transmission of content data between corresponding terminals; and

allowing direct printing of content data without mediation of a personal computer or any other device.

The respective devices may be interconnected by wireless connection, such as a wireless LAN, Bluetooth, or infrared, instead of the wired connection using the cable.

Global IP addresses are allocated on the broadband network 110 like the Internet, while private IP addresses are generally allocated on a private network like a LAN. In such cases, there is a NAT (Network Address Translation) traversal problem. As is known in the art, the NAT traversal problem is solved by UPnP (Universal Plug and Play) technique, STUN (Simple Traversal of UDP through NAT) technique, TURN (Traversal Using Relay NAT), or ICE (Interactive Connectivity Establishment) technique.

The personal computer 104, the SIP server 106, and the printing terminal 108 of this embodiment are respectively equivalent to the transmission terminal, the mediation server, and the information output device in the claims of the invention. The CPU 10 of the personal computer 104 or the CPU 30 of the personal computer 112 corresponds to the controller in the claims of the invention.

### A-2. System Operation

In the content transmission system of FIG. 1, the personal computer 104 and the printing terminal 108 are respectively activated to make access as SIP clients to the SIP server 106. Each of the personal computer 104 and the printing terminal 108 outputs a registration request to the accessed SIP server 106 and sends information including its own SIP URI and IP address to the accessed SIP server 106 (broken line arrows 126 and 128). In this state, the SIP server 106 functions as both the registrar and the location server. In the SIP server 106, the CPU 20 accepts the registration request via the communication module 22 and registers the received information as the registration information 26 into the memory 24 as shown in FIG. 3.

The SIP server 106 accordingly has the registration information of the personal computer 104 and the printing terminal 108. The registration information 26 includes a SIP URI and an IP address correlated to each terminal and is managed by the CPU 20.

The SIP URI is expressed by, for example, an identifier sequence ‘sip:user@west.com’. This identifier sequence has an identifier (scheme) ‘sip’ representing SIP on the head, a user identifier ‘user’ in the next place, and a host name ‘west.com’ after the at mark @. The user identifier may be a user ID or user phone number. The host name may be a fully qualified domain name FQDN or an IP address. The host name may be followed by a port number or another optional parameter. The SIP URI may be replaced by SIPS URI, which is a secure SIP URI. In this case, the scheme on the head is ‘sips’.

On completion of the SIP-related advance preparation, a session is established between the corresponding devices by the SIP protocol.

The sender provides a desired print content as a delivery object and stores the desired print content as the content data 17 in the memory 14 of the personal computer 104 as shown in FIG. 2. The sender also provides printing conditions adopted for printing the print content by the printing terminal and manages the printing conditions in the form of the printing condition database 18 in the memory 14. The sender further provides a delivery address list including delivery addresses or destinations of the print content and stores the delivery address list as the delivery request information 16 in the memory 14.

The CPU 10 of the personal computer 104 reads out the delivery request information 16 and analyzes the delivery address list included in the delivery request information 16. The delivery address list includes the SIP URI of the printing terminal 108 as a delivery destination. The CPU 10 of the personal computer 104 refers to the analyzed delivery address list and specifies the printing terminal 108 as a receiver of the content data.

In the content transmission system of the embodiment, prior to delivery of the content data, the printing conditions are transmitted from the personal computer 104 to the printing terminal 108 via the SIP server 106 in the course of establishment of the session between the personal computer 104 and the printing terminal 108 as mentioned previously.

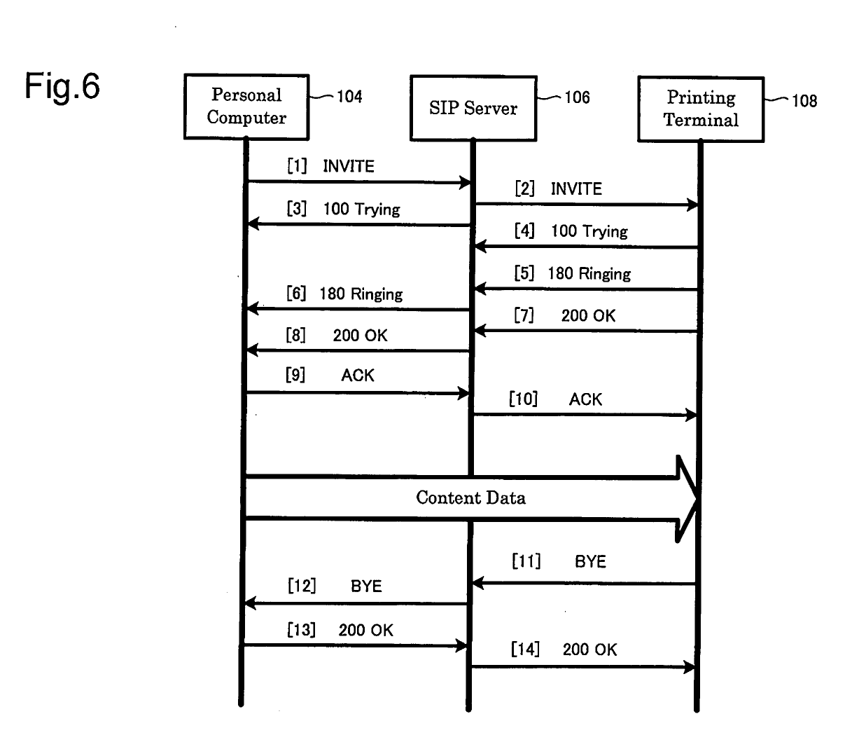

A sequence of session establishment between the personal computer 104 and the printing terminal 108 is described with reference to FIG. 6, prior to explanation on transmission of the printing conditions.

FIG. 6 shows a sequence of session establishment between the personal computer 104 and the printing terminal 108 in the content transmission system of FIG. 1. The time flows from the top to the bottom of FIG. 6, and the processing sequence goes in the order of numbers in the brackets.

In order to notify the printing terminal 108 of the IP address of the personal computer 104, the personal computer 104 includes the own IP address in the body of an INVITE request, which is to be sent to the printing terminal 108. Similarly in order to notify the personal computer 104 of the IP address of the printing terminal 108, the printing terminal 108 includes the own IP address in the body of a 200 OK response, which is to be sent to the personal computer 104.

When an ACK request sent from the personal computer 104 reaches the printing terminal 108, a session is established between the personal computer 104 and the printing terminal 108.

The personal computer 104 obtains the IP address of the printing terminal 108 from the received 200 OK response and makes direct access to the printing terminal 108 based on the IP address of the printing terminal 108 without requiring mediation by the SIP server 106. The personal computer 104 then delivers the content data in the ‘push’ type to the printing terminal 108 by the HTTP protocol (open arrow 122 in FIG. 1).

On completion of receiving the delivered content data, the printing terminal 108 sends a BYE request to the personal computer 104 via the SIP server 106 by the SIP protocol. The personal computer 104 receives the BYE request and sends back a 200 OK response to the printing terminal 108 via the SIP server 106. This closes the session between the personal computer 104 and the printing terminal 108.

In this sequence of session establishment, desired printing conditions are included in the body of the INVITE request and are sent from the personal computer 104 to the printing terminal 108.

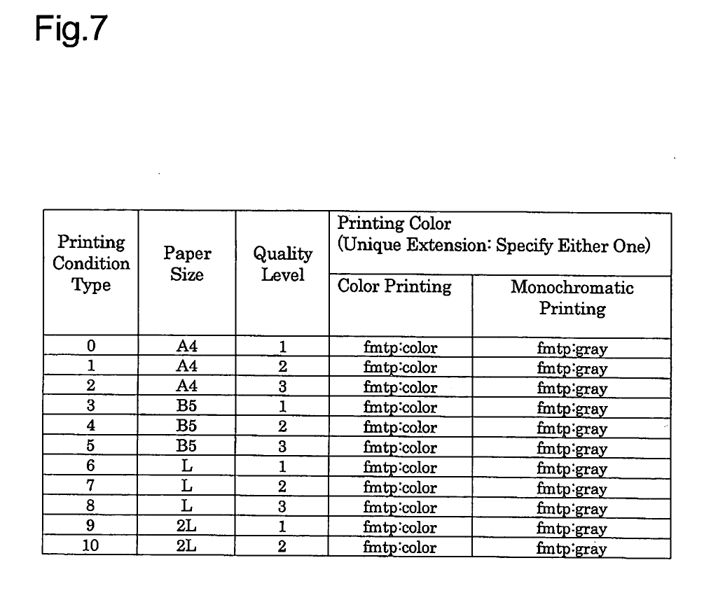

SDP (Session Description Protocol) is generally used for describing the contents of a media session in the course of the SIP-based session establishment between the corresponding devices. In the content transmission system of this embodiment, printing conditions to be sent are correlated to the existing SDP protocol as shown in FIG. 7.

FIG. 7 shows printing conditions correlated to the existing SDP protocol. In the table of FIG. 7, the item ‘printing condition type’ corresponds to a ‘payload type’ in the SDP definition. The item ‘printing color’ is uniquely extended from the existing SDP protocol and specifies either color printing or monochromatic printing as the printing condition.

The following description regards an SDP offer/answer model. In the SDP offer/answer model, one of two SIP UAs (user agents) establishing a session is specified as an offerer, and the other as an answerer. The offerer sends an SDP description document (offer) including session/media information as a proposal for a session to be established between the offerer and the answerer. In response to this proposal, the answerer sends back an SDP description document (answer) including session/media information. The framework establishing a session through this series of message exchange is the ‘offer/answer model’. In the content transmission system of the embodiment, the offerer or the sender represents the personal computer 104, while the answerer or the receiver represents the printing terminal 108.

The following describes transmission of the printing conditions in the content transmission system of the embodiment. In the content transmission system of this embodiment, the sender provides one print content C as a delivery object and two sets of printing conditions as available options of printing conditions adopted for printing the print content C by the printing terminal. The printing condition type follows the table of FIG. 7.

a. Printing Condition Type 0: A4, Color, Quality Level 1

b. Printing Condition Type 3: B5, Monochromatic, Quality Level 1

Content data corresponding to the two available sets of printing conditions are provided for the print content C.

a. Printing Condition Type 0: A4, Color, Quality Level 1
Content Data: image_a4_color.jpg

b. Printing Condition Type 3: B5, Monochromatic, Quality Level 1
Content Data: image_b5_gray.jpg

In the content transmission system of this embodiment, only one set of printing conditions with regard to one print content is transmittable from the offerer (sender) to the answerer (receiver). Namely only one set of printing conditions with regard to the print content C between the two available options of printing conditions is transmittable to the printing terminal 108. The option ‘a. printing condition type 0: A4, color, quality level 1’ is specified as a default set of printing conditions between the two available options of printing conditions and is transmitted to the printing terminal 108.

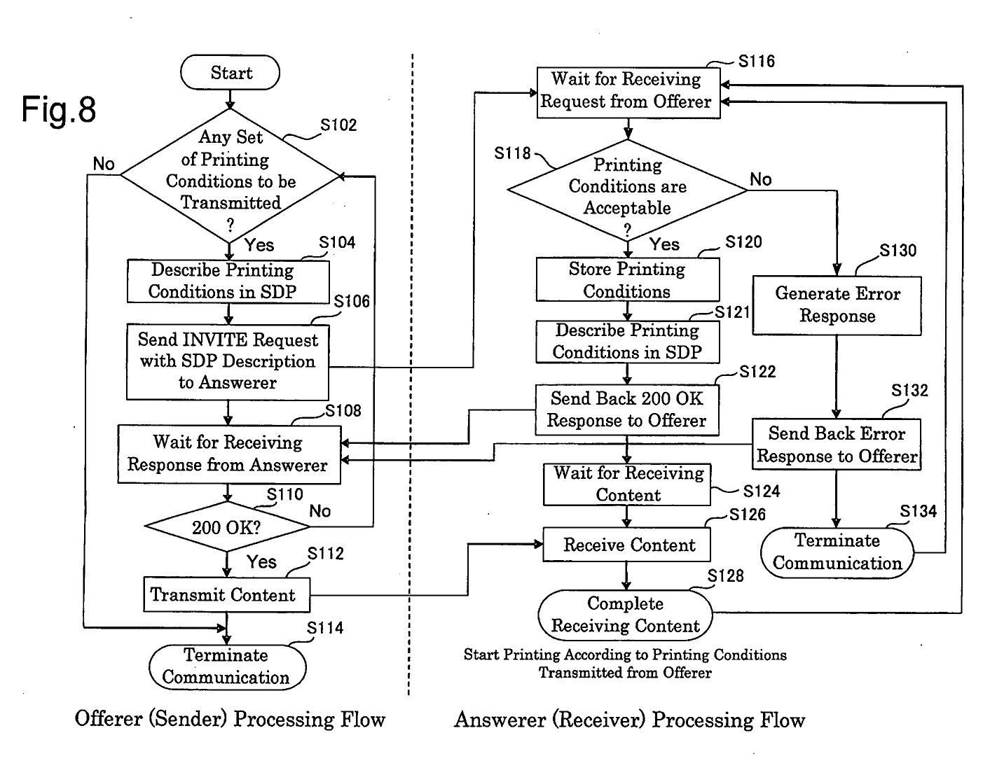

FIG. 8 is a flowchart showing a printing condition transmission routine executed in the content transmission system of FIG. 1. In the flowchart of FIG. 8, the left half shows a processing flow executed by the offerer or the personal computer 104, while the right half shows a processing flow executed by the answerer or the printing terminal 108.

The offerer (sender) first determines whether there is any set of printing conditions to be transmitted with regard to the print content C (step S102). When there is any set of printing conditions to be transmitted, the processing flow goes to step S104. The offerer (sender) describes the default set of printing conditions ‘a. printing condition type 0: A4, color, quality level 1’, as the set of printing conditions to be transmitted, in the body of an INVITE request by the SDP protocol (step S104). The SDP description is given below. This shows only a relevant part of the description relating to the set of printing conditions.

m=audio 49170 RTP/AVP 0
a=rtpmap: 0 PCMU/8000
a=fmtp: color

The numerical value written in the end of the ‘m=’ line (the 1^{st} line) is used for specifying the payload type in the SDP protocol. In this embodiment, this numerical value specifies the printing condition type. The numerical value ‘0’ represents the ‘printing condition type 0’. The 2^{nd} and the 3^{rd} lines describe the setting details with regard to the numerical value ‘0’.

The offerer (sender) sends the INVITE request with the SDP description to the answerer (receiver) (step S106). The offerer (sender) then waits for receiving a response from the answerer (receiver) (step S108).

In the meantime, the answerer (receiver) waits for receiving a request from the offerer (sender) (step S116). In response to receiving the INVITE request sent from the offerer (sender), the answerer (receiver) analyzes the SDP description in the body of the received INVITE request and determines whether the printing conditions described in the INVITE request are acceptable (printable) by the answerer (receiver) (step S118). According to a concrete procedure, the answerer (receiver) first identifies ‘0’ as the numerical value written in the end of the ‘m=’ line and recognizes that the set of printing conditions transmitted from the offerer (sender) is ‘printing condition type 0: A4, quality level 1’. The answerer (receiver) also specifies color printing based on the description on the 3^{rd} line ‘a=fmtp: color’.

Upon determination that the described printing conditions are acceptable by the answerer (receiver) at step S118, the answerer (receiver) keeps the printing conditions (step S120). In the printing terminal 108 as the answerer (receiver), the CPU 30 of the personal computer 112 stores the printing conditions as part of the content information 38 in the memory 34 as shown in FIG. 5.

The answerer (receiver) then describes the set of printing conditions in the body of a 200 OK response by the SDP protocol (step S121). Namely the SDP description transmitted from the offerer (sender) is copied into the body of the 200 OK response. The copied SDP description in the 200 OK response is identical with the SDP description in the INVITE request sent from the offerer (sender) as given below. This shows only a relevant part of the description relating to the set of printing conditions.

m=audio 49170 RTP/AVP 0
a=rtpmap: 0 PCMU/8000
a=fmtp: color

The answerer (receiver) sends back the 200 OK response with the SDP description to the offerer (sender) (step S122). The answerer (receiver) then waits for receiving content data (receiving standby state) (step S124).

Upon determination that the described printing conditions are unacceptable by the answerer (receiver) at step S118, on the other hand, the answerer (receiver) generates a ‘415 Unsupported Media Type’ response or ‘488 Not Acceptable Here’ response as an error response (step S130).

The answerer (receiver) sends back the generated error response to the offerer (sender) (step S132) and terminates the communication by the SIP protocol (step S134).

The offerer (sender) waiting for receiving a response from the answerer (receiver) receives a response sent back from the answerer (receiver) and identifies whether the received response is a 200 OK response (step S110).

When the received response is a 200 OK response at step S110, the offerer (sender) starts transmission of content data (step S112). As mentioned above, content data ‘image_a4_color.jpg’ is provided as the print content C corresponding to the set of printing conditions ‘printing condition type 0: A4, color, quality level 1’. This content data is sent to the answerer (receiver).

The answerer (receiver) waiting for receiving content data starts receiving the content data sent from the offerer (sender) (step S126). In the printing terminal 108 as the answerer (receiver), the CPU 30 of the personal computer 112 receives the content data via the communication module 32 and temporarily stores the received content data as the content data 36 in the memory 34 as shown in FIG. 5.

On completion of receiving the content data (step S128), the answerer (receiver) waits for receiving a request for a next print content from the offerer (sender) (step S116). Simultaneously the answerer (receiver) starts printing of the received content data according to the printing conditions ‘printing condition type 0: A4, color, quality level 1’ kept at step S120. In the printing terminal 108 as the answerer (receiver), the CPU 30 of the personal computer 112 reads the content data 36 from the memory 34, reads out the printing conditions transmitted from the offerer (sender) and included in the content information 38 stored in the memory 34, and makes the content data subjected to a required series of processing according to the printing conditions to convert the content data into a specific data form printable by the printer 114. The CPU 30 sends the converted content data with a print command to the printer 114. The printer 114 prints the converted content data and outputs a resulting print content.

In this manner, the printing terminal 108 as the answerer (receiver) gives a print result of the delivered content data according to the set of printing conditions transmitted from the offerer (sender).

When the response sent back from the answerer (receiver) is not a 200 OK response at step S110 but is an error response, the offerer (sender) determines whether there is any available set of printing conditions other than the default set of printing conditions ‘printing condition type 0: A4, color, quality level 1’ as the set of printing conditions to be transmitted (step S102).

As mentioned above, there is the available set of printing conditions ‘b. printing condition type 3: B5, monochromatic, quality level 1’ other than the default set of printing conditions ‘a. printing condition type 0: A4, color, quality level 1’. The offerer (sender) accordingly describes this available set of printing conditions ‘printing condition type 3: B5, monochromatic, quality level 1’, as another set of printing conditions to be transmitted, in the body of an INVITE request by the SDP protocol (step S104) and sends the INVITE request with the SDP description to the answerer (receiver) (step S106).

The SDP description is given below. This shows only a relevant part of the description relating to the set of printing conditions.

m=audio 49170 RTP/AVP 3
a=rtpmap: 3 GSM/8000
a=fmtp: gray
The processing of and after step S108 is then performed as described above.

When the offerer (sender) determines at step S102 that there is no available set of printing conditions other than the default set of printing conditions ‘printing condition type 0: A4, color, quality level 1’ or when the answerer (receiver) determines at step S118 that the newly transmitted printing conditions ‘printing condition type 3: B5, monochromatic, quality level 1’ are still unacceptable by the answerer (receiver), the offerer (sender) terminates the communication by the SIP protocol (step S114).

### A-3. Effects of Embodiment

In the content transmission system of the first embodiment, in the course of establishment of a session between the personal computer 104 and the printing terminal 108 prior to delivery of content data, the set of printing conditions is transmitted from the personal computer 104 as the offerer (sender) to the printing terminal 108 as the answerer (receiver) via the SIP server 106. The printing terminal 108 as the answerer (receiver) then prints the delivered content data according to the set of printing conditions transmitted from the offerer (sender). This arrangement enables the answerer (receiver) to output a print result meeting the sender user's requirements.

### B. Second Embodiment

In the content transmission system of the first embodiment, only one set of printing conditions with regard to one print content is transmittable from the personal computer 104 as the offerer (sender) to the printing terminal 108 as the answerer (receiver). In a content transmission system of a second embodiment, on the other hand, multiple sets of printing conditions with regard to one print content are transmittable from the offerer (sender) to the answerer (receiver). The answerer (receiver) then sends back an acceptable set of printing conditions out of the multiple received sets of printing conditions to the offerer (sender).

### B-1. System Configuration

The configuration of the content transmission system of the second embodiment is identical with the configuration of the content transmission system of the first embodiment shown in FIG. 1 and is thus not specifically described here. The structures of the respective devices as the constituents of the content transmission system of the second embodiment are also identical with those of the first embodiment shown in FIGS. 2 through 5 and are thus not specifically described here.

### B-2. System Operation

As mentioned above, the content transmission system of the second embodiment has the difference from the content transmission system of the first embodiment with regard to only the printing condition transmission process. Otherwise the operations of the content transmission system of the second embodiment are similar to those of the content transmission system of the first embodiment. The following description mainly regards the difference.

The following describes transmission of the printing conditions in the content transmission system of the second embodiment. In the content transmission system of this embodiment, the sender provides one print content C as a delivery object and three sets of printing conditions as available options of printing conditions adopted for printing the print content C by the printing terminal. The printing condition type follows the table of FIG. 7.

a. Printing Condition Type 0: A4, Color, Quality Level 1

b. Printing Condition Type 3: B5, Monochromatic, Quality Level 1

c. Printing Condition Type 7: L, Color, Quality Level 2

Content data corresponding to the three available sets of printing conditions are provided for the print content C.

a. Printing Condition Type 0: A4, Color, Quality Level 1
Content Data: image_a4_color.jpg

b. Printing Condition Type 3: B5, Monochromatic, Quality Level 1
Content Data: image_b5_gray.jpg

c. Printing Condition Type 7: L, Color, Quality Level 2
Content Data: image_{—}1_color.jpg

In the content transmission system of the second embodiment, multiple sets of printing conditions with regard to one print content are transmittable from the offerer (sender) to the answerer (receiver) as explained above. All the three available sets of printing conditions with regard to the provided print content C are thus transmitted to the printing terminal 108 in this embodiment.

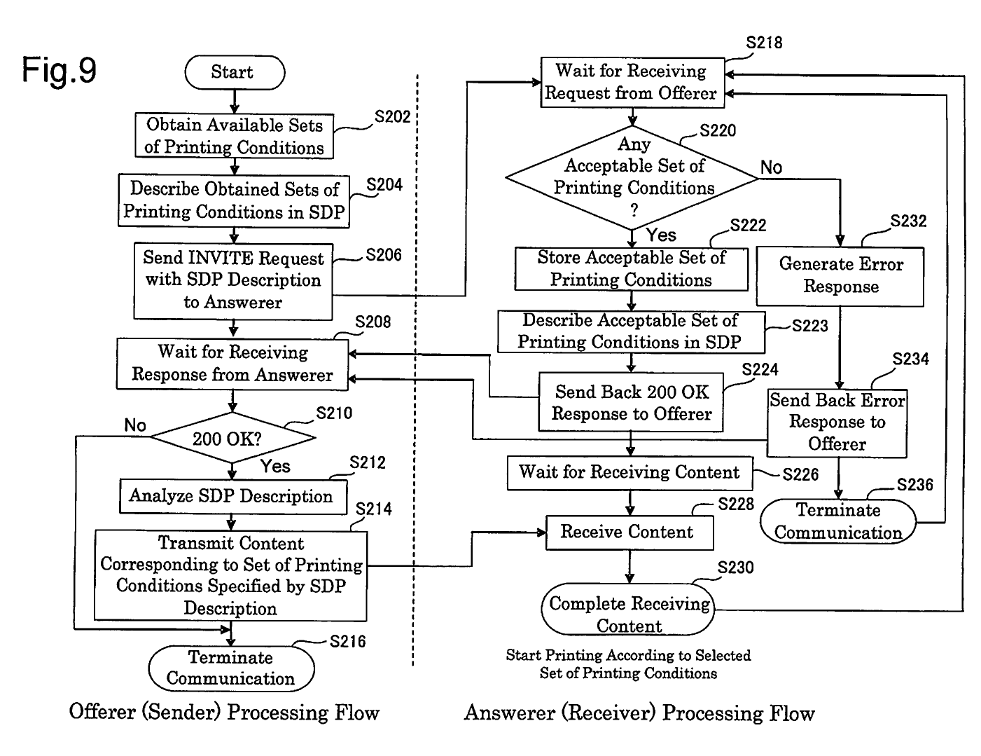

FIG. 9 is a flowchart showing a printing condition transmission routine executed in the content transmission system of the second embodiment. As in the flowchart of FIG. 8, in the flowchart of FIG. 9, the left half shows a processing flow executed by the offerer or the personal computer 104, while the right half shows a processing flow executed by the answerer or the printing terminal 108.

The offerer (sender) first obtains all the three available sets of printing conditions as the set of printing conditions to be transmitted with regard to the print content C (step S202) and describes the three available sets of printing conditions in the body of an INVITE request by the SDP protocol (step S204). The SDP description is given below. This shows only a relevant part of the description relating to the three sets of printing conditions. The numerical values at the head are line numbers used for explanation.

1: m=audio 49170 RTP/AVP 0 3 7
2: a=rtpmap: 0 PCMU/8000
3: a=fmtp: color
4: a=rtpmap: 3 GSM/8000
5: a=fmtp: gray
6: a=rtpmap: 7 LPC/8000
7: a=fmtp: color

The numerical value written in the end of the ‘m=’ line (the 1^{st} line) specifies the printing condition type as explained previously. The numerical values ‘0’, ‘3’, and ‘7’ respectively represent the ‘printing condition type 0’, the ‘printing condition type 3’, and the ‘printing condition type 7’. The ‘a=’ lines (2^{nd} to 7^{th} lines) subsequent to the ‘m=’ line describe the setting details with regard to the respective numerical values. The 2^{nd} and the 3^{rd} lines describe the setting details with regard to the numerical value ‘0’. The 4^{th} and the 5^{th} lines describe the setting details with regard to the numerical value ‘3’. The 6^{th} and the 7^{th} lines describe the setting details with regard to the numerical value ‘7’.

The offerer (sender) sends the INVITE request with the SDP description to the answerer (receiver) (step S206). The offerer (sender) then waits for receiving a response from the answerer (receiver) (step S208).

In the meantime, the answerer (receiver) waits for receiving a request from the offerer (sender) (step S218). In response to receiving the INVITE request sent from the offerer (sender), the answerer (receiver) analyzes the SDP description in the body of the received INVITE request and determines whether the printing conditions described in the INVITE request are acceptable (printable) by the answerer (receiver) (step S220). The answerer (receiver) first analyzes the ‘m=’ line as the 1^{st} line defined by the line number 1 among the SDP description in the body of the INVITE request.

1: m=audio 49170 RTP/AVP 0 3 7

In the definition of the SDP protocol, the numerical values ‘0’, ‘3’, and ‘7’ in the end of the ‘m=’ line are arranged in the order of priority. The answerer (receiver) evaluates the multiple sets of printing conditions in this priority order.

The answerer (receiver) first identifies ‘0’ as the first numerical value written in the end of the ‘m=’ line and recognizes that the first set of printing conditions is ‘printing condition type 0: A4, quality level 1’. As mentioned above, the 2^{nd} and the 3^{rd} lines defined by the line numbers 2 and 3 describe the setting details with regard to the numerical value ‘0’. The answerer (receiver) specifies color printing based on the description on the 3^{rd} line ‘a=fmtp: color’.

The answerer (receiver) determines whether the first set of printing conditions ‘printing condition type 0: A4, color, quality level 1’ is acceptable by the answerer (receiver). When the first set of printing conditions is acceptable by the answerer (receiver), the answerer (receiver) keeps the first set of printing conditions (step S222). In the printing terminal 108 as the answerer (receiver), the CPU 30 of the personal computer 112 stores the first set of printing conditions as part of the content information 38 in the memory 34 as shown in FIG. 5.

The answerer (receiver) then describes the first set of printing conditions in the body of a 200 OK response by the SDP protocol (step S223). The SDP description is given below. This shows only a relevant part of the description relating to the set of printing conditions.

m=audio 49170 RTP/AVP 0
a=rtpmap: 0 PCMU/8000
a=fmtp: color

The answerer (receiver) sends back the 200 OK response with the SDP description to the offerer (sender) (step S224). The answerer (receiver) then waits for receiving content data (receiving standby state) (step S226). The answerer (receiver) does not send back multiple sets of printing conditions to the offerer (sender).

In VoIP (Voice over Internet Protocol) softphone and equipment, there is only one ‘m=’ line for each medium. The following example gives description for transmission and reception of voice and image. For simultaneous transmission and reception of different media (voice and image), one ‘m=’ line is provided for each medium, and the attribute regarding the medium is described below the corresponding ‘m=’ line.

m=audio . . .
a=rtpmap . . .
m=video . . .
a=rtpmap . . .
a= . . .

The following description (establishment of two sessions for transmission and reception of voice) is generally not allowed, since this may lead to failed voice communication.

m=audio . . .
a=rtpmap . . .
a= . . .
m=audio . . .
a=rtpmap . . .
a= . . .

In the content transmission system of this embodiment, the multiple sets of printing conditions are described as the ‘m=audio . . . ’ and are apparently treated as one specifiable audio medium.

When the first set of printing conditions ‘printing condition type 0: A4, color, quality level 1’ is unacceptable by the answerer (receiver), the answerer (receiver) subsequently identifies ‘3’ as the second numerical value written in the end of the ‘m=’ line and recognizes that the second set of printing conditions is ‘printing condition type 3: B5, quality level 1’. As mentioned above, the 4^{th} and the 5^{th} lines defined by the line numbers 4 and 5 describe the setting details with regard to the numerical value ‘3’. The answerer (receiver) specifies monochromatic printing based on the description on the 5^{th} line ‘a=fmtp: gray’.

The answerer (receiver) determines whether the second set of printing conditions ‘printing condition type 3: B5, monochromatic, quality level 1’ is acceptable by the answerer (receiver). When the second set of printing conditions is acceptable by the answerer (receiver), the answerer (receiver) keeps the second set of printing conditions.

The answerer (receiver) then describes the second set of printing conditions in the body of a 200 OK response by the SDP protocol and sends back the 200 OK response with the SDP description to the offerer (sender).

The SDP description is given below. This shows only a relevant part of the description relating to the set of printing conditions.

m=audio 49170 RTP/AVP 3
a=rtpmap: 3 GSM/8000
a=fmtp: gray

When the second set of printing conditions ‘printing condition type 3: B5, monochromatic, quality level 1’ is unacceptable by the answerer (receiver), the answerer (receiver) subsequently identifies ‘7’ as the third numerical value written in the end of the ‘m=’ line and recognizes that the third set of printing conditions is ‘printing condition type 7: L, quality level 2’. As mentioned above, the 6^{th} and the 7^{th} lines defined by the line numbers 6 and 7 describe the setting details with regard to the numerical value ‘7’. The answerer (receiver) specifies color printing based on the description on the 7^{th} line ‘a=fmtp: color’.

The answerer (receiver) determines whether the third set of printing conditions ‘printing condition type 7: L, color, quality level 2’ is acceptable by the answerer (receiver). When the third set of printing conditions is acceptable by the answerer (receiver), the answerer (receiver) keeps the third set of printing conditions.

The answerer (receiver) then describes the third set of printing conditions in the body of a 200 OK response by the SDP protocol and sends back the 200 OK response with the SDP description to the offerer (sender). The SDP description is given below. This shows only a relevant part of the description relating to the set of printing conditions.

m=audio 49170 RTP/AVP 7
a=rtpmap: 7 LPC/8000
a=fmtp: color

When the third set of printing conditions ‘printing condition type 7: L, color, quality level 2’ is unacceptable by the answerer (receiver), that is, when all the three sets of printing conditions transmitted from the offerer (sender) are unacceptable by the answerer (receiver), the answerer (receiver) generates a ‘415 Unsupported Media Type’ response or ‘488 Not Acceptable Here’ response as an error response (step S232).

The answerer (receiver) sends back the generated error response to the offerer (sender) (step S234) and terminates the communication by the SIP protocol (step S236).

The offerer (sender) waiting for receiving a response from the answerer (receiver) receives a response sent back from the answerer (receiver) and identifies whether the received response is a 200 OK response (step S210).

When the received response is a 200 OK response at step S210, the offerer (sender) analyzes the SDP description in the body of the 200 OK response (step S212) and starts transmission of content data corresponding to the printing conditions specified by the SDP description (step S214). For example, when the SDP description in the body of the 200 OK response specifies the second set of printing conditions ‘printing condition type 3: B5, monochromatic, quality level 1’ as the set of printing conditions acceptable by the answerer (receiver), content data ‘image_b5_gray.jpg’ is sent to the answerer (receiver), since the content data ‘image_b5_gray.jpg’ is provided as the print content C corresponding to the second set of printing conditions ‘printing condition type 3: B5, monochromatic, quality level 1’.

The answerer (receiver) waiting for receiving content data starts receiving the content data sent from the offerer (sender) (step S228). In the printing terminal 108 as the answerer (receiver), the CPU 30 of the personal computer 112 receives the content data via the communication module 32 and temporarily stores the received content data as the content data 36 in the memory 34 as shown in FIG. 5.

On completion of receiving the content data (step S230), the answerer (receiver) waits for receiving a request for a next print content from the offerer (sender) (step S218). Simultaneously the answerer (receiver) starts printing of the received content data according to the printing conditions ‘printing condition type 3: B5, monochromatic, quality level 1’ kept at step S222. In the printing terminal 108 as the answerer (receiver), the CPU 30 of the personal computer 112 reads the content data 36 from the memory 34, reads out the printing conditions transmitted from the offerer (sender) and included in the content information 38 stored in the memory 34, and makes the content data subjected to a required series of processing according to the printing conditions to convert the content data into a specific data form printable by the printer 114. The CPU 30 sends the converted content data with a print command to the printer 114. The printer 114 prints the converted content data and outputs a resulting print content.

In this manner, the printing terminal 108 as the answerer (receiver) selects the set of printing conditions acceptable by the answerer (receiver) out of the multiple sets of printing conditions transmitted from the offerer (sender) and gives a print result of the delivered content data according to the selected set of printing conditions.

When the response sent back from the answerer (receiver) is not a 200 OK response at step S210 but is an error response, this means that all the three sets of printing conditions are unacceptable by the answerer (receiver). The offerer (sender) then terminates communication by the SIP protocol (step S216).

### B-3. Effects of Embodiment

In the content transmission system of the second embodiment, in the course of establishment of a session between the personal computer 104 and the printing terminal 108 prior to delivery of content data, the multiple sets of printing conditions are transmitted from the personal computer 104 as the offerer (sender) to the printing terminal 108 as the answerer (receiver) via the SIP server 106. The answerer (receiver) selects the acceptable set of printing conditions out of the multiple sets of printing conditions and sends back the selected set of printing conditions to the offerer (sender). The offerer (sender) then sends content data corresponding to the selected set of printing conditions to the answerer (receiver). The printing terminal 108 as the answerer (receiver) prints the delivered content data according to the set of printing conditions selected out of the multiple sets of printing conditions. This arrangement enables the answerer (receiver) to output a print result meeting the receiver user's requirements as well as the sender user's requirements.

### C. Third Embodiment

In the content transmission systems of the first and the second embodiments, only one print content is simultaneously transmittable from the personal computer 104 as the offerer (sender) to the printing terminal 108 as the answerer (receiver). In a content transmission system of a third embodiment, on the other hand, multiple print contents are simultaneously transmittable from the offerer (sender) to the answerer (receiver). The expression of ‘simultaneously transmitting multiple print contents’ means that data of multiple print contents are sequentially transmitted in an identical session established.

### C-1. System Configuration

The configuration of the content transmission system of the third embodiment is identical with the configuration of the content transmission system of the first embodiment shown in FIG. 1 and is thus not specifically described here. The structures of the respective devices as the constituents of the content transmission system of the third embodiment are also identical with those of the first embodiment shown in FIGS. 2 through 5 and are thus not specifically described here.

### C-2. System Operation

As mentioned above, the content transmission system of the third embodiment has the difference from the content transmission system of the first embodiment with regard to only the printing condition transmission process. Otherwise the operations of the content transmission system of the third embodiment are similar to those of the content transmission system of the first embodiment. The following description mainly regards the difference.

The following describes transmission of the printing conditions in the content transmission system of the third embodiment. In the content transmission system of this embodiment, the sender provides three print contents C1 to C3 as delivery objects and three sets of printing conditions as available printing conditions adopted for printing the respective print contents C1 to C3 by the printing terminal. The printing condition type follows the table of FIG. 7.

a. Print Content C1

Content Data: image1.jpg

Printing Condition Type 0: A4, Color, Quality Level 1

b. Print Content C2

Content Data: image2.jpg

Printing Condition Type 3: B5, Monochromatic, Quality Level 1

c. Print Content C3

Content Data: image3.jpg

Printing Condition Type 7: L, Color, Quality Level 2

In the content transmission system of the third embodiment, multiple print contents are simultaneously transmittable from the offerer (sender) to the answerer (receiver) as explained above. Plural print contents acceptable by the answerer (receiver) among the three print contents C1 to C3 provided by the offerer (sender) are simultaneously transmitted to the answerer (receiver) in this embodiment.

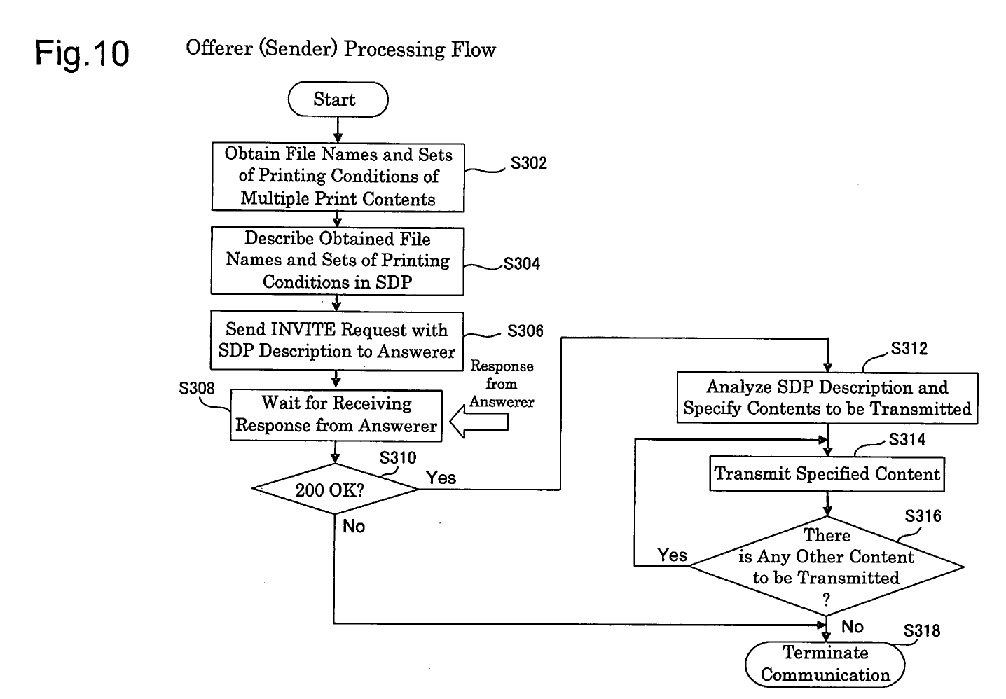

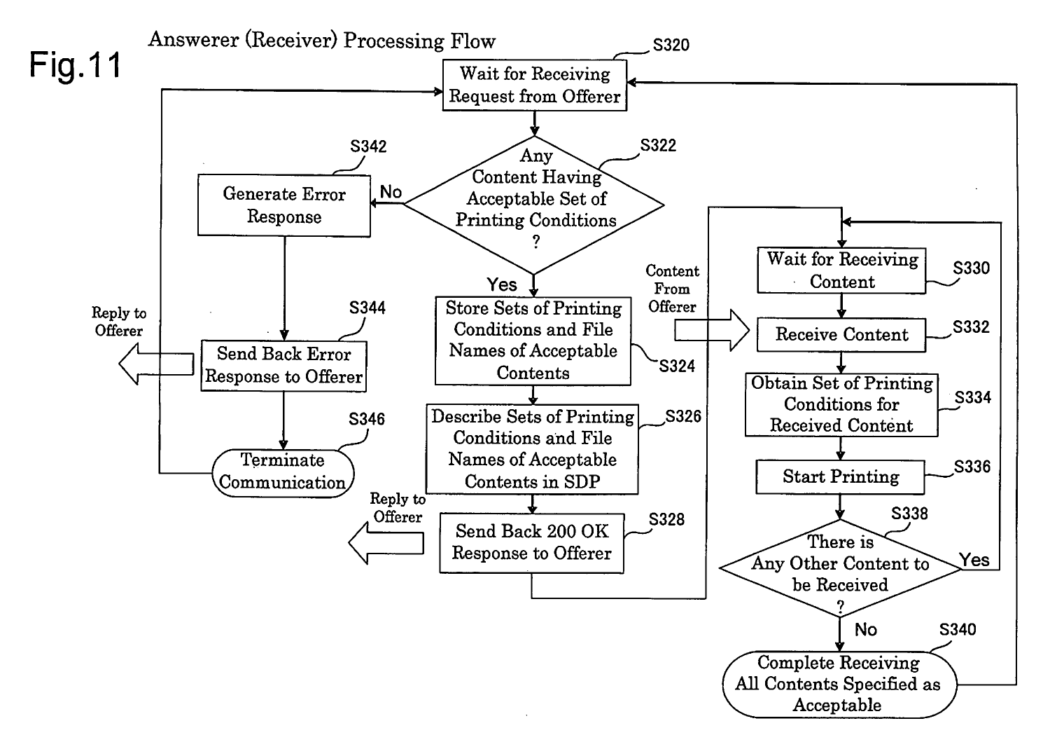

FIG. 10 is a flowchart showing an offerer processing flow included in a printing condition transmission routine executed in the content transmission system of the third embodiment. FIG. 11 is a flowchart showing an answerer processing flow included in the printing condition transmission routine executed in the content transmission system of the third embodiment. Namely the processing flow of FIG. 10 is executed by the personal computer 104, while the processing flow of FIG. 11 is executed by the printing terminal 108.

The offerer (sender) obtains a file name and a corresponding set of printing conditions with regard to each of the three print contents C1 to C3 as delivery objects (step S302) and describes the file names and the respective sets of printing conditions corresponding to the three print contents C1 to C3 in the body of an INVITE request by the SDP protocol (step S304). The SDP description is given below. This shows only a relevant part of the description relating to the respective sets of printing conditions. The numerical values at the head are line numbers used for explanation.

1: m=audio 49170 RTP/AVP 0 3 7
2: a=rtpmap: 0 PCMU/8000
3: a=fmtp: color
4: a=file: image1.jpg
5: a=rtpmap: 3 GSM/8000
6: a=fmtp: gray
7: a=file: image2.jpg
8: a=rtpmap: 7 LPC/8000
9: a=fmtp: color
10: a=file: image3.jpg

The numerical value written in the end of the ‘m=’ line (the 1^{st} line) specifies the printing condition type as explained previously. The numerical values ‘0’, ‘3’, and ‘7’ respectively represent the ‘printing condition type 0’, the ‘printing condition type 3’, and the ‘printing condition type 7’. The ‘a=’ lines (2^{nd} to 10^{th} lines) subsequent to the ‘m=’ line describe the setting details with regard to the respective numerical values. The 2^{nd} through the 4^{th} lines describe the setting details with regard to the numerical value ‘0’. The 5^{th} through the 7^{th} lines describe the setting details with regard to the numerical value ‘3’. The 8^{th} through the 10^{th} lines describe the setting details with regard to the numerical value ‘7’.

Unlike the SDP description of the second embodiment, the file names of the respective print contents as delivery objects are added to the 4^{th}, the 7^{th}, and the 10^{th} lines. The description of the 4^{th}, the 7^{th}, and the 10^{th} lines is unique extension from the standard SDP definition.

As mentioned previously, in the standard SDP definition, the numerical values in the end of the ‘m=’ line representing the payload types are arranged in the priority order. In the content transmission system of the second embodiment, the answerer (receiver) evaluates the multiple sets of printing conditions in this priority order and sends back a 200 OK response to the offerer (sender) in response to identification of the acceptable set of printing conditions (media setting). The answerer (receiver) accordingly does not send back multiple sets of printing conditions (media setting). Namely in the content transmission system of the second embodiment, only one print content is simultaneously transmittable from the offerer (sender) to the answerer (receiver).

The content transmission system of the third embodiment, on the other hand, uniquely extends the SDP definition to allow simultaneous transmission of multiple print contents from the offerer (sender) to the answerer (receiver). The numerical values in the end of the ‘m=’ line are not arranged in the priority order but represent the types of print contents to be transmitted.

The following shows print contents corresponding to the respective numerical values ‘0’, ‘3’, and ‘7’ with their setting details.

‘0’:

Print Content C1

Content Data: image1.jpg

Printing Condition Type 0: A4, Color, Quality Level 1

‘3’:

Print Content C2

Content Data: image2.jpg

Printing Condition Type 3: B5, Monochromatic, Quality Level 1

‘7’

Print Content C3

Content Data: image3.jpg

Printing Condition Type 7: L, color, Quality Level 2

The offerer (sender) sends the INVITE request with the SDP description to the answerer (receiver) (step S306). The offerer (sender) then waits for receiving a response from the answerer (receiver) (step S308).

In the meantime, the answerer (receiver) waits for receiving a request from the offerer (sender) (step S320). In response to receiving the INVITE request sent from the offerer (sender), the answerer (receiver) analyzes the SDP description in the body of the received INVITE request and determines whether there is any print content having a set of printing conditions acceptable (printable) by the answerer (receiver) (step S322). The answerer (receiver) first analyzes the ‘m=’ line as the 1^{st} line defined by the line number 1 among the SDP description in the body of the INVITE request.

1: m=audio 49170 RTP/AVP 0 3 7

The answerer (receiver) sequentially makes evaluation and analyzes the following ‘a=’ lines to determine whether each print content defined by the numerical value is acceptable by the answerer (receiver) according to the corresponding set of printing conditions. For example, with regard to the first numerical value ‘0’, the answerer (receiver) recognizes that the set of printing conditions is ‘printing condition type 0: A4, quality level 1’. As mentioned above, the 2^{nd} through the 4^{th} lines defined by the line numbers 2 through 4 describe the setting details with regard to the numerical value ‘0’. The answerer (receiver) specifies color printing based on the description on the 3^{rd} line ‘a=fmtp: color’, and identifies the file name ‘image1.jpg’ based on the description on the 4^{th} line ‘a=file: image1.jpg’. The answerer (receiver) then determines whether the print content having the file name ‘image1.jpg’ is acceptable by the answerer (receiver) according to the set of printing conditions ‘printing condition type 0: A4, quality level 1’.

For example, it is determined at step S322 that the two print contents corresponding to the first numerical value ‘0’ and the third numerical value ‘7’ are acceptable by the answerer (receiver) according to their sets of printing conditions. The following shows the print contents acceptable by the answerer (receiver) and their sets of printing conditions.

‘0’:

Print Content C1

Content Data: image1.jpg

Printing Condition Type 0: A4, Color, Quality Level 1

‘7’

Print Content C3

Content Data: image3.jpg

Printing Condition Type 7: L, color, Quality Level 2

The answerer (receiver) then keeps the sets of printing conditions and the file names of the acceptable print contents (step S324). In the printing terminal 108 as the answerer (receiver), the CPU 30 of the personal computer 112 stores the sets of printing conditions and the file names of the acceptable print contents as part of the content information 38 in the memory 34 as shown in FIG. 5. The file names are not specifically illustrated in FIG. 5.

The answerer (receiver) then describes the sets of printing conditions and the file names of the acceptable print contents in the body of a 200 OK response by the SDP protocol (step S326). The SDP description is given below. This shows only a relevant part of the description relating to the respective sets of printing conditions. The numerical values at the head are line numbers used for explanation.

1: m=audio 49170 RTP/AVP 0 7
2: a=rtpmap: 0 PCMU/8000
3: a=fmtp: color
4: a=file: image1.jpg
5: a=rtpmap: 7 LPC/8000
6: a=fmtp: color
7: a=file: image3.jpg

The answerer (receiver) sends back the 200 OK response with the SDP description to the offerer (sender) (step S328). The answerer (receiver) then waits for receiving content data (receiving standby state) (step S330).

When it is determined at step S322 that there is no print content having a set of printing conditions acceptable by the answerer (receiver), the answerer (receiver) generates a ‘415 Unsupported Media Type’ response or ‘488 Not Acceptable Here’ response as an error response (step S342).

The answerer (receiver) sends back the generated error response to the offerer (sender) (step S344) and terminates the communication by the SIP protocol (step S346).

The offerer (sender) waiting for receiving a response from the answerer (receiver) receives a response sent back from the answerer (receiver) and identifies whether the received response is a 200 OK response (step S310).

When the received response is a 200 OK response at step S310, the offerer (sender) analyzes the SDP description in the body of the 200 OK response and specifies one or plural print contents to be transmitted among the three provided print contents C1 to C3 according to the analyzed SDP description (step S312). The offerer (sender) then starts transmission of content data of the specified print contents (step S314). The offerer (sender) first analyzes the ‘m=’ line as the 1^{st} line defined by the line number 1 among the SDP description in the body of the 200 OK response as given below and then analyzes the following ‘a=’ lines.

1: m=audio 49170 RTP/AVP 0 7

As the result of the analysis, the offerer (sender) specifies the two print contents C1 and C3 corresponding to the first numerical value ‘0’ and the third numerical value ‘7’ as the print contents to be transmitted. The offerer (sender) then sequentially sends content data of these specified print contents C1 and C3 (steps S314, S316). The following shows the print contents and the corresponding sets of printing conditions sent from the offerer (sender).

‘0’:

Print Content C1

Content Data: image1.jpg

Printing Condition Type 0: A4, Color, Quality Level 1

‘7’

Print Content C3

Content Data: image3.jpg

Printing Condition Type 7: L, color, Quality Level 2

The answerer (receiver) waiting for receiving content data starts receiving the content data sent from the offerer (sender) (step S332). The answerer (receiver) first receives content data under the file name ‘image1.jpg (print content C1) and subsequently receives content data under the file name ‘image3.jpg’ (print content C3). In the printing terminal 108 as the answerer (receiver), the CPU 30 of the personal computer 112 receives the content data via the communication module 32 and temporarily stores the received content data as the content data 36 in the memory 34 as shown in FIG. 5.

On completion of receiving the content data of the print content C1 (file name ‘image1.jpg’) (step S332), the answerer (receiver) obtains the set of printing conditions for the print content C1 ‘printing condition type 0: A4, color, quality level 1’ kept at step S324 (step S334) and starts printing of the received content data (step S336). In the printing terminal 108 as the answerer (receiver), the CPU 30 of the personal computer 112 reads the content data 36 from the memory 34 based on the file name included in the content information 38, reads out the printing conditions included in the content information 38 stored in the memory 34, and makes the content data subjected to a required series of processing according to the printing conditions to convert the content data into a specific data form printable by the printer 114. The CPU 30 sends the converted content data with a print command to the printer 114. The printer 114 prints the converted content data and outputs a resulting print content.

In the meantime, the answerer (receiver) determines whether there is any other print content to be received (step S338). When there is any other print content to be received, the answerer (receiver) again waits for receiving content data (receiving standby state) (step S330) and starts receiving content data of the next print content C3 (file name ‘image3.jpg’) (step S332). On completion of receiving the content data of the print content C3 (step S332), the answerer (receiver) obtains the set of printing conditions for the print content C3 ‘printing condition type 7: L, color, quality level 2’ kept at step S324 (step S334) and starts printing of the received content data (step S336). On completion of receiving and printing content data of all the print contents specified as acceptable (step S340), the answerer (receiver) waits for receiving a request for a next print content from the offerer (sender) (step S320).

In this manner, the printing terminal 108 as the answerer (receiver) gives print results of the plural print contents simultaneously sent from the offerer (sender) according to the respective sets of printing conditions transmitted from the offerer (sender).

When the response sent back from the answerer (receiver) is not a 200 OK response at step S310 but is an error response, this means that all the three provided print contents are unacceptable by the answerer (receiver). The offerer (sender) then terminates communication by the SIP protocol (step S318).

### C-3. Effects of Embodiment

In the content transmission system of the third embodiment, in the course of establishment of a session between the personal computer 104 and the printing terminal 108 prior to delivery of content data, the sets of printing conditions and the file names with regard to multiple print contents are transmitted from the personal computer 104 as the offerer (sender) to the printing terminal 108 as the answerer (receiver) via the SIP server 106. The answerer (receiver) selects one or plural acceptable print contents among the multiple print contents according to the corresponding sets of printing conditions and sends a response on the selection to the offerer (sender). The offerer (sender) sends content data of the selected print contents to the answerer (receiver). In the content transmission system of the third embodiment, plural print contents are thus transmittable simultaneously from the personal computer 104 as the offerer (sender) to the printing terminal 108 as the answerer (receiver). This arrangement enables the answerer (receiver) to output print results of plural print contents meeting the receiver user's requirements as well as the sender user's requirements.

### D. Fourth Embodiment

In the content transmission system of the first embodiment described above, the sender provides in advance content data as a delivery object and a set of printing conditions adopted for printing the content data by the printing terminal and stores the content data and the set of printing conditions in the memory 14 of the personal computer 104 shown in FIG. 2. This configuration is, however, neither essential nor restrictive. In one modified configuration, the sender may scan an image with a scanner, specify image data of the scanned image as content data, and specify scanning conditions for scanning the image as a set of printing conditions adopted for printing the content data by the printing terminal. Such configuration is described below as a fourth embodiment.

### D-1. System Configuration

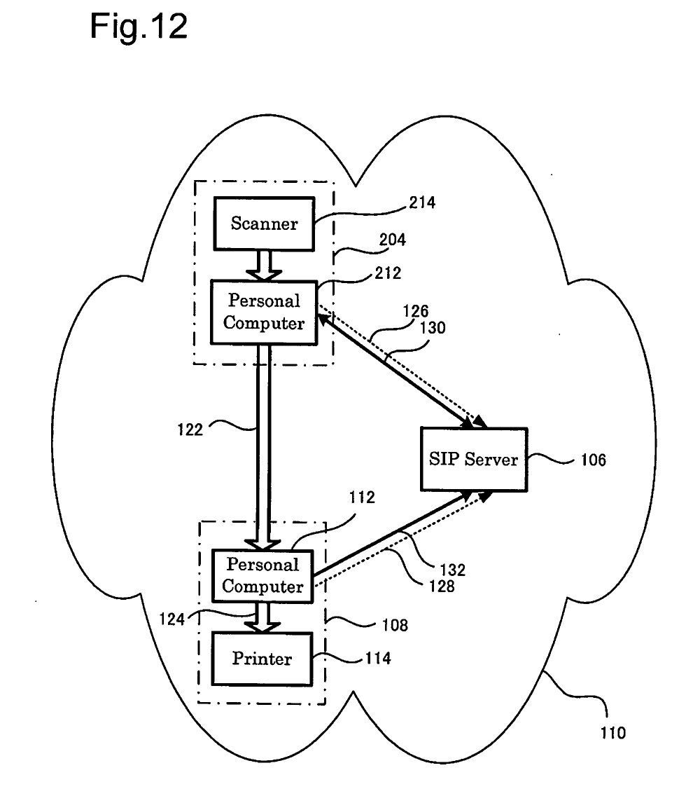

FIG. 12 is a block diagram schematically illustrating the configuration of a content transmission system in the fourth embodiment of the invention.

As shown in FIG. 12, the difference of the content transmission system of the fourth embodiment from the content transmission system of the first embodiment is that a transmission terminal 204 under management of the sender user desiring delivery of print contents includes a personal computer 212 and a scanner 214 connected to the personal computer 212 by a USB cable or another equivalent means. Otherwise the content transmission system of the fourth embodiment has the similar configuration to that of the content transmission system of the first embodiment. The same constituents are expressed by the like numerals and are not specifically described here.

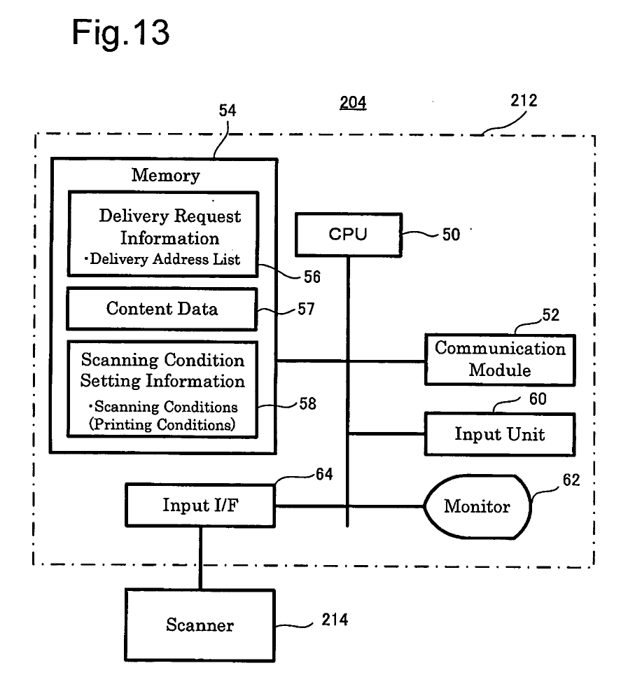

FIG. 13 is a block diagram showing the primary structure of the transmission terminal 204 included in the content transmission system of FIG. 12. As shown in FIG. 13, the personal computer 212 mainly includes a CPU 50 configured to perform diversity of processing operations and controls according to programs, a communication module 52 configured to transmit various data and information to and from other devices via a network, a memory 54 configured to store programs as well as data and information therein, an input unit 60 constructed to have a keyboard and a pointing device and configured to enter the user's instructions and commands, a monitor 62 configured to display the obtained data and information, and an input interface (I/F) 64 configured to input data from the externally connected scanner 214 or another externally connected device. The memory 54 is capable of storing delivery request information 56, content data 57, and scanning condition setting information 58 as part of the storable data and information.

In the content transmission system of this embodiment, the transmission terminal 204 is constructed to have the personal computer 212 and the scanner 214 directly connected with the personal computer 212 by the USB cable or another equivalent means. The transmission terminal 204 is, however, not restricted to this construction but may have any of other various arrangements.

In one modified arrangement, the scanner 214 may be replaced with a complex machine. In another modified arrangement, the transmission terminal 204 may be constructed by the personal computer 212 and a network-ready complex machine or scanner connected to the personal computer 212 via a LAN by a LAN cable or another equivalent means. In still another modified arrangement, the transmission terminal 204 may be constructed by the personal computer 212, a network adapter connected to the personal computer 212 via a LAN by a LAN cable or another equivalent means, and a complex machine or a scanner connected to the network adapter by a USB cable or another equivalent means. In another modified arrangement, the transmission terminal 204 may be constructed by an IP (Internet Protocol) printing-compatible complex machine alone.

The respective devices may be interconnected by wireless connection, such as a wireless LAN, Bluetooth, or infrared, instead of the wired connection using the cable.

The scanner 214 and the SIP server 106 of this embodiment are respectively equivalent to the image scanner and the mediation server in the claims of the invention.

### D-2. System Operation

In the content transmission system of FIG. 12, the personal computer 212 of the transmission terminal 204 is activated to make access as a SIP client to the SIP server 106, output a registration request to the accessed SIP server 106, and send information including its own SIP URI and IP address to the accessed SIP server 106 (broken line arrow 126). The SIP server 106 accepts the registration request and registers the received information from the personal computer 212 as the registration information 26 into the memory 24 as shown in FIG. 3. The registration information of the printing terminal 108 is also registered in the memory 24 of the SIP server 106.

The sender user managing the transmission terminal 204 operates the input unit 60 of the personal computer 212 (FIG. 13) to activate a specific program (not shown). The CPU 50 displays a scanning condition setting window (not shown) on the monitor 62 according to the specific program. The sender user subsequently operates the input unit 60 to enter the sender user's desired scanning conditions adopted for image scan by the scanner 214 in the scanning condition setting window. The scanning conditions include the paper size (prescan size, for example, size A4, size B5, or size L), the scanning color (chromatic, monochromatic), and the scanning quality (quality level 1, quality level 2). The CPU 50 stores the scanning conditions entered via the input unit 60 as the scanning condition setting information 58 into the memory 54.

When the sender user operates the input unit 60 to give an instruction for starting image scan, the CPU 50 reads out the scanning condition setting information 58 from the memory 54 and obtains the scanning conditions included in the scanning condition setting information 58. The CPU 50 transmits the scanning conditions with an image scan start command to the scanner 214 via the input I/F 64. In response to the image scan start command, the scanner 214 starts scanning the image according to the scanning conditions and outputs image data of the scanned image. The CPU 50 receives the image data via the input I/F 64 and stores the received image data as the content data 57 into the memory 54. The sender provides a delivery address list for a print content and stores the delivery address list as the delivery request information 56 in the memory 54 of the personal computer 212. The CPU 50 reads out the delivery request information 56 from the memory 54 and analyzes the delivery address list included in the delivery request information 56. The delivery address list includes, for example, the SIP URI of the printing terminal 108 as a delivery destination. The CPU 50 specifies the printing terminal 108 as a receiver of content data according to the delivery address list.

On specification of the receiver of the content data, the personal computer 212 of the transmission terminal 204 establishes a session with the printing terminal 108 as the receiver as described above in the first embodiment.

Prior to establishment of a session, the CPU 50 of the personal computer 212 reads out the scanning condition setting information 58 from the memory 54 and obtains the scanning conditions included in the scanning condition setting information 58. In the course of session establishment, the CPU 50 sends the obtained scanning conditions to the printing terminal 108 as a set of printing conditions adopted for printing the content data. According to a concrete procedure, the printing conditions (scanning conditions) are described in the body of an INVITE request, which is sent from the personal computer 212 to the printing terminal 108, by the SDP protocol as explained previously in the first embodiment. For example, when the scanning conditions are ‘paper size: A4, scanning color: chromatic, scanning quality: quality level 1’, the set of printing conditions ‘printing condition type 0: A4, color, quality level 1’ shown in FIG. 7 is described in the body of the INVITE request.

On establishment of a session with the printing terminal 108, the personal computer 212 sends the content data 57 stored in the memory 54 to the printing terminal 108 by the HTTP protocol as explained previously in the first embodiment. The printing terminal 108 then prints the content data according to the previously received printing conditions and outputs a resulting print content.

### D-3. Effects of Embodiment

In the content transmission system of the fourth embodiment, the transmission terminal 204 scans an image with the scanner 214 and delivers image data of the scanned image as the content data 57 to the printing terminal 108. In the course of establishment of a session with the printing terminal 108, the transmission terminal 204 sends the scanning conditions of the image scan as printing conditions for printing the content data by the printing terminal 108 to the printing terminal 108. The printing terminal 108 then prints the delivered content data according to the transmitted printing conditions, that is, the scanning conditions of the image scan. This arrangement enables the printing terminal 108 to output a print result meeting the sender user's requirements.

### E. Other Aspects

The embodiments and their applications discussed above are to be considered in all aspects as illustrative and not restrictive. There may be many modifications, changes, and alterations without departing from the scope or spirit of the main characteristics of the present invention.

In the content transmission systems of the embodiments discussed above, the printing conditions are managed in the form of the printing condition database 18 as separate data from the content data 17. This arrangement is, however, neither essential nor restrictive. The printing conditions may be embedded in the header of the content data or may be kept as default setting in the sender (offerer) device or in the software, independently of the content data.

In the content transmission systems of the first and the second embodiments discussed above, the offerer (sender) provides content data corresponding to each set of printing conditions with regard to one identical print content. This arrangement is, however, neither essential nor restrictive. In one modification, the offerer (sender) may provide high-quality content data, convert the content data into an optimum format (for example, resolution and color) for the set of printing conditions acceptable by the answerer (receiver), and send the converted content data to the answerer (receiver). In another modification, a specific server may be provided to be connected with the personal computer 104 as the offerer (sender) directly or via a network. The specific server performs conversion of the content data into the optimum format for the acceptable set of printing conditions.

In the content transmission system of the third embodiment discussed above, the answerer (receiver) keeps the sets of printing conditions and the file names of the acceptable print contents at step S324 in the flowchart of FIG. 11. This arrangement is, however, neither essential nor restrictive. In one modification, at step S314 in the flowchart of FIG. 10, the offerer (sender) may embed the corresponding set of printing conditions in the header of content data of each acceptable print content and send the content data with the embedded printing conditions to the answerer (receiver). At step S332 in the flowchart of FIG. 11, the answerer (receiver) analyzes the header of the received content data to obtain the embedded set of printing conditions. In this modified arrangement, the answerer (receiver) is not required to keep the sets of printing conditions and the file names of the acceptable print contents at step S324 in the flowchart of FIG. 11.

The content transmission system of the fourth embodiment specifies the set of scanning conditions and scans an image with the scanner 214 according to the specified set of scanning conditions. In one modification, the content transmission system may specify multiple different sets of scanning conditions and scan one identical image according to the multiple different sets of scanning conditions to obtain multiple different content data. In this case, multiple sets of scanning conditions are specified with regard to one identical image, and content data corresponding to each set of scanning conditions is obtained. As discussed above, the content transmission system of the fourth embodiment regards the scanning conditions as the printing conditions. Namely multiple sets of printing conditions are provided with regard to one identical print content, and content data corresponding to each set of printing conditions is generated.

As discussed in the first embodiment, when one set of printing conditions (scanning conditions) sent from the personal computer 212 to the printing terminal 108 is unacceptable by the printing terminal 108, another set of printing conditions (scanning conditions) may be sent from the personal computer 212 to the printing terminal 108. As discussed in the second embodiment, the personal computer 212 may send multiple sets of printing conditions (multiple sets of scanning conditions) with regard to one identical print content to the printing terminal 108. The printing terminal 108 may send back an acceptable set of printing conditions selected among the multiple sets of printing conditions to the personal computer 212.

In another modification of the fourth embodiment, the content transmission system may provide multiple images and specify a set of scanning conditions corresponding to each of the multiple images for scanning the image with the scanner 214. The content transmission system of this modified arrangement may scan the multiple images according to the respective corresponding sets of scanning conditions to obtain multiple content data. In this case, a corresponding set of scanning conditions is specified for each of multiple different images, and content data of each image is obtained according to the corresponding set of scanning conditions. As discussed above, the content transmission system of the fourth embodiment regards the scanning conditions as the printing conditions. Namely multiple sets of printing conditions are provided corresponding to multiple different print contents, and content data of each print content is generated according to the corresponding set of printing conditions.

As discussed in the third embodiment, the personal computer 212 may simultaneously send corresponding sets of printing conditions (scanning conditions) and file names of multiple print contents to the printing terminal 108. The printing terminal 108 may send back a corresponding set of printing conditions and a file name of an acceptable print content selected among the multiple print contents to the personal computer 212.

In the content transmission systems of the above embodiments, the network is a broadband network, such as the Internet. The network may otherwise be, for example, a mobile telephone network or a public telephone network.

The content transmission systems of the above embodiments adopt SIP as the signaling protocol. This is, however, not restrictive, but any of H.323, MGCP (Media Gateway Control Protocol), and MEGACO (Media Gateway Control) may be used instead of SIP. The content transmission systems of the above embodiments adopt HTTP as the data transfer protocol. This is, however, not restrictive, but any of FTP, RTP (Realtime Transport Protocol), IRC (Internet Relay Chat), and TELNET may be used instead of HTTP. Diversity of similar techniques having the global address management function and the presence service function, for example, Skype (registered trademark) and Instant Messaging, may alternatively be used for the session establishment and for the data transfer.

In the content transmission systems of the above embodiments, the SIP server is used as the proxy server to mediate establishment of a session. The SIP protocol enables establishment of a session in peer-to-peer fashion as long as SIP clients are notified of the SIP URIs and IP addresses of the others. In this case, the SIP clients may directly establish a session without mediation of the SIP server.

In the content transmission systems of the above embodiments, content data is delivered in the ‘push’ type from the personal computer as the offerer (sender) to the printing terminal as the answerer (receiver). This is, however, not restrictive, but the content data may be delivered in a ‘pull’ type. In the ‘pull’-type delivery, a terminal sends a request for data delivery to a server, and the server delivers data to the terminal in response to the request.

In the content transmission systems of the above embodiments, the IP addresses are used as location information on the network. MAC (Media Access Control) addresses may alternatively be used as location information on the network.

In the content transmission systems of the above embodiments, the printing conditions specify the paper size, the printing quality, and the printing color. The printing conditions may additionally include the paper type (plain paper, glossy paper) and the On/Off state of an automatic image correction function.

In the content transmission systems of the above embodiments, the transmission terminal or the offerer (sender) is constructed by the personal computer 104. This configuration is, however, neither essential nor restrictive. For example, the offerer (sender) may be constructed by a content delivery server that receives a request from each content provider and delivers a desired print content on behalf of the content provider. In this modified configuration, the printing conditions may be determined according to the history database of each content provider or may be registered in advance for each content provider.

In the content transmission systems of the above embodiments, the printing terminal is used as the information output device. This is, however, not restrictive. The technique of the present invention is also applicable to transmission of display conditions including a display resolution from a transmission terminal to a display in the course of delivery of content data, such as an image, from the transmission terminal to the display. The technique of the invention is further applicable to transmission of audio output conditions including a mute condition from a transmission terminal to an audio device in the course of delivery of content data, such as sound, from the transmission terminal to the audio device. A telephone or a television set may also be used as the information output device.

Finally the present application claims the priorities based on Japanese Patent Application No. 2007-295652 filed on Nov. 14, 2007, No. 2008-6875 filed on Jan. 16, 2008, and No. 2008-267080 filed on Oct. 16, 2008, which are herein incorporated by reference.

What is claimed is:

1. A transmission terminal constructed to send content data to an information output device via a network, the transmission terminal comprising:
a controller configured to establish a session with the information output device via a mediation server connecting with the network by a signaling protocol, prior to sending the content data,
the controller sending an output condition, which is adopted by the information output device for outputting information based on the content data, via the mediation server to the information output device in the course of establishment of the session.

2. The transmission terminal in accordance with claim 1, the transmission terminal further comprising:
an image scanner configured to scan an image according to a scanning condition and obtain image data of the scanned image as the content data,
wherein the controller sends the scanning condition as the output condition to the information output device via the mediation server in the course of establishment of the session.

3. The transmission terminal in accordance with claim 1, wherein the signaling protocol is SIP protocol, and
the controller includes the output condition in an INVITE request, which is sent to the information output device via the mediation server by the SIP protocol.

4. The transmission terminal in accordance with claim 1, wherein the controller sends multiple different conditions as the output condition.

5. The transmission terminal in accordance with claim 4, wherein when the controller plans to send multiple different data as the content data to the information output device after establishment of the session, the multiple different conditions are respectively provided corresponding to the multiple different data.

6. The transmission terminal in accordance with claim 1, wherein the controller sends data corresponding to the output condition as the content data by a data transfer protocol after establishment of the session.

7. An information output device constructed to receive content data from a transmission terminal via a network and output information based on the received content data, the information output device comprising:
a controller configured to establish a session with the transmission terminal via a mediation server connecting with the network by a signaling protocol, prior to receiving the content data,
the controller receiving an output condition, which is adopted for outputting the information based on the content data, in the course of establishment of the session, and sending back a response to the output condition to the transmission terminal via the mediation server.

8. The information output device in accordance with claim 7, wherein the controller determines whether output of the information according to the received output condition is enabled or disabled and sends back a result of the determination as the response to the output condition to the transmission terminal via the mediation server.

9. The information output device in accordance with claim 7, wherein when receiving multiple different conditions as the output condition in the course of establishment of the session, the controller selects a desired condition among the multiple different conditions and sends back a result of the selection as the response to the output condition to the transmission terminal via the mediation server.

10. A content transmission system constructed to transmit content data via a network, the content transmission system comprising:
a transmission terminal connected to the network and configured to send the content data via the network;
an information output device connected to the network and configured to receive the content data from the transmission terminal and output information based on the received content data; and
a mediation server connected to the network,
prior to transmission of the content data, the transmission terminal and the information output device establishing a session between the transmission terminal and the information output device via the mediation server by a signaling protocol,
in the course of establishment of the session, the transmission terminal sending an output condition, which is adopted by the information output device for outputting the information based on the content data, to the information output device via the mediation server.
